(19) United States
(12) Patent Application Publication
(10) Pub. No.: US 2025/0190117 A1
(43) Pub. Date: Jun. 12, 2025

(54) AUTOMATED VERIFICATION ENVIRONMENT SANITY CHECKER AND METHOD THEREOF

(71) Applicant: SK hynix Inc., Gyeonggi-do (KR)

(72) Inventors: Andrey KUYEL, Minsk (BY); Dmitry TELPUK, Gdansk (PL)

(21) Appl. No.: 18/533,627

(22) Filed: Dec. 8, 2023

(51) Int. Cl. G06F 3/06

(52) U.S. Cl. CPC G06F 3/0614; G06F 3/0653; G06F 3/0679

(57) ABSTRACT

A verification environment sanity checker and method for simulating a design under test (DUT) of a verification environment. The verification environment sanity checker includes a fault injector injects, to a simulation engine, at least one fault for at least one feature among the DUT features for at least one component of the DUT components such that the simulation engine simulates the DUT by injecting the fault into the DUT and a test bench tests the feature for the DUT. A verification environment parser analyzes a test result for the DUT associated with the feature, and produces an error list indicating an error of the DUT associated with the feature. The fault injector detects whether a faulty operation corresponding to the feature is captured, based on the error list.

### BACKGROUND

### 1. Field

Embodiments of the present disclosure relate to design verification schemes for a memory system.

### 2. Description of the Related Art

Continually evolving storage solutions, increasing design complexity of storage or memory systems (e.g., SSD controller) and highly competitive storage market (e.g., NAND storage market) impose short time to the market schedule, outstanding product quality and robustness. Design verification methods, verification frameworks, and test environments employed for memory systems continuously evolve to respond to storage (e.g., NAND) solution's ever-growing design complexity and memory system's design verification challenges.

The complexity of design verification solutions leads to situations where verification and test suite components themselves may include faults that may result in undetected SSD controllers design flaws and false positive design sign-off criteria. In consideration of the foregoing premises, a design verification engineer faces the challenge of ensuring that the verification environment itself is bug-free and reliable.

One of the commonly accepted solutions to the issues above is accompanying the verification test suite with unit tests that will check the functionality of the verification test suite functionality. The major limitation of such an approach is an increased number of skilled verification engineers designated for unit tests development are required in order to meet a short product time to the market schedule.

### SUMMARY

Aspects of the present invention include an apparatus and a method for automated, random, and parameterized cross-check of verification environment components of memory systems.

In one aspect of the present invention, a verification environment sanity checker is coupled to a verification environment including a design under test (DUT) and a verification test bench. The verification environment sanity checker includes: a verification environment parser coupled to the verification test bench; a design parser coupled to the DUT, and configured to decompound the DUT to produce a component list of DUT components; a simulation engine coupled to the verification environment, and configured to simulate the DUT; and a fault injector coupled between the verification environment parser and the simulation engine, and configured to receive the components list, a particular faults injection script and a features checklist for DUT features, and inject, to the simulation engine, at least one fault for at least one feature among the DUT features for at least one component of the DUT components based on the components list and the features checklist such that the simulation engine simulates the DUT by injecting the fault into the DUT and the verification test bench tests the feature for the DUT. The verification environment parser is configured to receive a test result for the DUT associated with the feature, analyze the test result and produce an error list indicating an error of the DUT associated with the feature based on the test result. The fault injector is configured to receive the error list from the verification environment parser, analyze the error list, and detect whether a faulty operation corresponding to the feature is captured, based on the analysis result.

In one aspect of the present invention, a method of operating a verification environment sanity checker coupled to a verification environment including a design under test (DUT) and a verification test bench, includes: receiving, by a fault injector, a component list of DUT components, a particular faults injection script and a features checklist for DUT features; injecting, by the fault injector, to a simulation engine, at least one fault for at least one feature among the DUT features for at least one component of the DUT components based on the components list and the features checklist; simulating, by a simulation engine, the DUT by injecting the fault into the DUT such that the verification test bench tests the feature for the DUT; receiving and analyzing, by a verification environment parser, a test result for the DUT associated with the feature; producing, by the verification environment parser, an error list indicating an error of the DUT associated with the feature based on the test result; receiving and analyzing, by the fault injector, the error list from the verification environment parser; and detecting, by the fault injector, whether a faulty operation corresponding to the feature is captured, based on the analysis result.

Additional aspects of the present invention will become apparent from the following description.

### BRIEF DESCRIPTION OF THE DRAWINGS

FIG. 1 is a block diagram illustrating verification environment in accordance with one embodiment of the present invention.

FIG. 2 is a block diagram illustrating verification environment sanity checker in accordance with another embodiment of the present invention.

FIGS. 3A and 3B illustrate a flow of a verification environment sanity checking operation in accordance with another embodiment of the present invention.

FIG. 4 illustrates a up counter implemented as a design under test (DUT) in accordance with another embodiment of the present invention.

FIG. 5 is a flowchart illustrating an operation of a verification environment sanity check in accordance with another embodiment of the present invention.

### DETAILED DESCRIPTION

Various embodiments of the present invention are described below in more detail with reference to the accompanying drawings. The present invention may, however, be embodied in different forms and thus should not be construed as limited to the embodiments set forth herein. Rather, these embodiments are provided so that this disclosure conveys the scope of the present invention to those skilled in the art. Moreover, reference herein to “an embodiment,” “another embodiment,” or the like is not necessarily to only one embodiment, and different references to any such phrase are not necessarily to the same embodiment(s). The term “embodiments” as used herein does not necessarily refer to all embodiments. Throughout the disclosure, like reference numerals refer to like parts in the figures and embodiments of the present invention.

The present invention can be implemented in numerous ways, including as a process; an apparatus; a system; a computer program product embodied on a computer-readable storage medium; and/or a processor, such as a processor suitable for executing instructions stored on and/or provided by a memory coupled to the processor. In this specification, these implementations, or any other form that the present invention may take, may be referred to as techniques. In general, the order of the operations of disclosed processes may be altered within the scope of the present invention. Unless stated otherwise, a component such as a processor or a memory described as being suitable for performing a task may be implemented as a general component that is temporarily configured to perform the task at a given time or a specific component that is manufactured to perform the task. As used herein, the term ‘processor’ or the like refers to one or more devices, circuits, and/or processing cores suitable for processing data, such as computer program instructions.

The methods, processes, and/or operations described herein may be performed by code or instructions to be executed by a computer, processor, controller, or other signal processing device. The computer, processor, controller, or other signal processing device may be those described herein or one in addition to the elements described herein. Because the algorithms that form the basis of the methods (or operations of the computer, processor, controller, or other signal processing device) are described in detail, the code or instructions for implementing the operations of the method embodiments may transform the computer, processor, controller, or other signal processing device into a special-purpose processor for performing methods herein.

When implemented at least partially in software, the controllers, processors, devices, modules, units, multiplexers, generators, logic, interfaces, decoders, drivers, generators and other signal generating and signal processing features may include, for example, a memory or other storage device for storing code or instructions to be executed, for example, by a computer, processor, microprocessor, controller, or other signal processing device.

A detailed description of the embodiments of the present invention is provided below along with accompanying figures that illustrate aspects of the present invention. The present invention is described in connection with such embodiments, but the present invention is not limited to any particular embodiment. The present invention encompasses numerous alternatives, modifications and equivalents. Numerous specific details are set forth in the following description in order to provide a thorough understanding of the present invention. These details are provided for the purpose of example; the present invention may be practiced without some or all of these specific details. For clarity, technical material that is known in technical fields related to the present invention may not been described in detail.

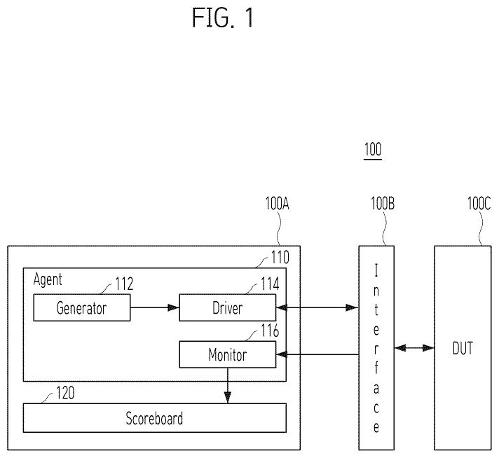

Design verification is an important step in the development of any product. Design verification ensures that the product is implemented in accordance with design specification. Register Transfer Level (RTL) testbench environment is one of the main engineering tools used for memory systems (e.g., solid state drive (SSD) controllers) design verification. RTL verification environment may include many interconnected sophisticated components as shown in FIG. 1.

Referring to FIG. 1, verification environment 100 may be responsible for generating input stimulus, driving an input stimulus, monitoring design activity at the output and input level, comparing output transaction correctness based on the driven input stimulus, and sampling function convergence and assertion correctness. The verification environment 100 may include a verification testbench 100A, design under test 100C and an interface 100B coupled between the verification testbench 100A and the design under test 100C. The verification testbench 100A may include an agent 110 and a scoreboard 120. The agent 110 may comprise a generator 112, a driver 114 and a monitor 116.

The generator 112 in one embodiment creates or generates randomized transactions or stimuli and passes them to the driver 114. The driver 114 interacts with DUT 100C through the interface 100B. The driver 114 receives randomized transactions from the generator 112 and drives the transactions as a pin level activity. The monitor 116 observes pin-level activity on the connected interface 100B at the input and output of the DUT 100C. This pin-level activity is converted into a transaction packet and sent to the scoreboard 120 for checking purposes.

The scoreboard 120 receives the transaction packet from the monitor 116 and compares the received transaction packet with a reference model. The reference module is written based on design specification understanding and design behavior. The transaction packet comprises a structure that is used to communicate with the DUT 100C.

One objective of the verification environment is to confirm that a designed system implements all specification requirements, typically by providing a stimulus to the designed system (i.e., DUT such as SSD controller) and monitoring corresponding responses to determine whether the requirement(s) is met. Usually, verification environments for SSD controller are complex, implemented, and deployed by several design verification engineers. Therefore, test environment implementation flaw and inconsistencies with DUT specification may occur. Verification environment inconsistency with the examined DUT may lead to false positive design sign-off criteria.

Accordingly, embodiments of the present invention provide an automated solution for verification environment sanity check for consistency with verified DUT features, minimization of verification components DUT specification misinterpretation, and design flaw identification both in the verification environment and DUT. Various embodiments of the present invention offer the employment of a method and apparatus for automated, random, and parameterized cross-check of verification environment components. Various embodiments of the present invention make it possible to promptly deploy an automated testing framework that checks verification environment completeness by generating DUT misbehavior.

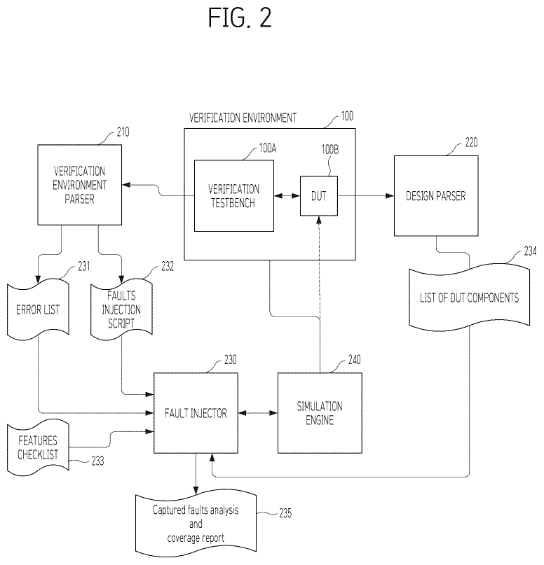

FIG. 2 is a block diagram illustrating verification environment sanity checker in accordance with one embodiment of the present invention.

Referring FIG. 2, the verification environment sanity checker comprises verification environment 100 including the design under test (DUT) 100B and the verification test bench 100A. In some embodiments, the DUT 100B may include but is not limited to a system on-chip (SoC) module for a memory controller of a memory system (e.g., SSD controller).

The verification environment sanity checker may include verification environment parser (VEP) 210, a design parser (DP) 220, a fault injector (FI) 230 and a simulation engine (SE) 240.

The verification environment parser 210 may be coupled to the verification test bench 100A. The design parser 220 may be coupled to the DUT 100B and be configured to decompose the DUT 100B to produce a component list of DUT components 234.

The simulation engine 240 may be coupled to the verification environment 100 and be configured to simulate the DUT 100B.

The fault injector 230 may be coupled between the verification environment parser 210 and the simulation engine 240. The fault injector 230 may be configured to receive the components list 234, a particular faults injection script 232 and a features checklist 233 for DUT features. Further, the fault injector 230 may be configured to inject, to the simulation engine 240, at least one fault for at least one feature among the DUT features for at least one component of the DUT components based on the components list 234 and the features checklist 233 such that the simulation engine 240 simulates the DUT 100B by injecting the fault into the DUT 100B and the verification test bench 100A tests the feature for the DUT 100B.

The verification environment parser 210 may be configured to receive a test result for the DUT 100B associated with the feature, analyze the test result and produce an error list 231 indicating an error of the DUT associated with the feature based on the test result.

The fault injector 230 may be configured to receive the error list 231 from the verification environment parser 210, analyze the error list 231, and detect whether a faulty operation of the DUT simulation corresponding to the feature is captured, based on the analysis result and an expected error based on the fault injected.

In some embodiments, the fault injector 230 may be further configured to generate a report associated with the detection of the faulty operation.

In some embodiments, a faults injection script may include an instruction set for combinational or sequential fault injections of two or more of a) incorrect finite state machine (FSM) state transition, b) unsynchronized clock domains clock phase shifting, c) incorrect modules interconnection, d) incorrect register value change, and e) communication protocol violations.

In some embodiments, another faults injection script 232 may be generated by the verification environment parser 210 and afterward populated by a user (e.g., a verification engineer). In some embodiments, the features checklist 233 may be provided by a user (e.g., a verification engineer).

In some embodiments, the design parser 220 may include a Hardware Description Language (HDL) design parser.

In some embodiments, the simulation engine 240 may include a Hardware Description Language (HDL) simulation engine.

In some embodiments, faults injection script 232 may support one or more faults injection scenarios in one of the HDL or other high-level program languages.

In some embodiments, fault injector 230 may be coupled to the HDL simulation engine 240 through a dedicated programming interface.

In some embodiments, the verification environment sanity checker (VESC) may include components which are implemented with a Hardware Description Language (HDL). That is, the verification environment sanity checker (VESC) includes four components: the verification environment parser (VEP) 210, HDL design parser (HDLDP) 220, fault injector (FI) 230, and HDL simulation engine (SE) 240.

The VEP 210 receives the verification environment 100 which should be examined for verification environment consistency with one or more DUT features. The VEP 210 decomposes and analyzes the verification environment 100 to produce a list 231 of all errors reported for operation misbehaviors or failures of one or more DUT features. In some embodiments, the VEP 210 includes one or more checkers to check operation misbehaviors or failures on one or more DUT features, and the list 231 covers all DUT misbehaviors or failures of one or more DUT features.

The HDLDP 220 receives the DUT 100B result that is tested by the verification environment 100, decomposes the received DUT to sub-elements and produces the list 234 of DUT elements (or components) applicable for fault injection or fault-inducing injection. In some embodiments, the fault injection may be combinational fault injection for injecting two or more design faults in combination, or sequential fault injection for injecting two or more faults in sequence. A design fault is an error, flaw, or coding bug in the design, development, or operation of system-on chip (SoC) module (i.e., SSD controller) that causes the DUT to produce an incorrect or unexpected result, or to behave in unintended ways when the fault injection occurs. In some embodiments, one of possible design faults to produce an expected error in simulation of the DUT includes one or more of a) incorrect state transition of finite state machine (FSM), b) unsynchronized clock phase shifting of clock domains, c) incorrect interconnection of modules, d) incorrect change of register value, and/or e) violations of communication protocol.

The FI 230 receives the list 231 of verification environment errors, faults injection script 232, DUT features checklist 233, and the list 234 of DUT elements eligible for fault injection. In some embodiments, the fault injection script 232 or a template for the fault injection script may be generated automatically by the VEP 210 and afterward populated by VESC user (or engineer). The fault injection script includes instructions set (i.e., code lines) sufficient to control and construct one or more DUT fault injection scenarios. One fault injection scenario may be conditioned in the fault injection script. This implies that only if a certain condition in DUT state is met, a specified fault injection scenario is exercised. Condition fault injection facilitates a transient DUT corrupted state, which is more difficult to detect than a hardcoded DUT design flaw. The DUT feature checklist 233 maps between DUT features, fault injection scenarios, and verification environment error or error messages.

The FI 230 is coupled to the HDL SE 240 by a dedicated programming interface and may control the simulation process for the verification environment 100 (i.e., DUT 100B). In some embodiments, HDL simulation engine may be used for the SE 240. The HDL SE 240 is a software package simulating expressions and logic written in one of HDL or other high-level program languages. The HDL SE 240 stimulates the DUT 100B and executes the verification environment 100. The FI 230 is dynamically coupled with the SE 240 and constantly monitors one or more states of the DUT 100B for the satisfaction of simulation conditions, defined in the fault injection script, for fault injection scenario activation. Active coupling between the FI 230 and SE 240 enables dynamic, conditioned, and multiple faults injection scenarios execution during a single simulation execution base on DUT internal state.

Upon reception of all input parameters (i.e., error list 231, fault injection script 232, features check list 233, list of DUT components 234, and establishing coupling with simulation engine 240), the FI 230 starts the HDL SE 240 to simulate the verification environment 100 and the DUT 100B. Through SE application programming interface (API), the FI 230 launches the simulation, injects one or more faults based on the fault injection script 232, and collects statistics regarding reported/caught faults during the simulation. Upon simulation completion, the FI 230 presents or generates a faults analysis and coverage report based on the execution of the simulation.

As such, the verification environment sanity checker cross-checks whether the verification environment 100 successfully detects the errors caused by the faults injected into the DUT 100B, and hence determines if proper operation of verification environment components occurred.

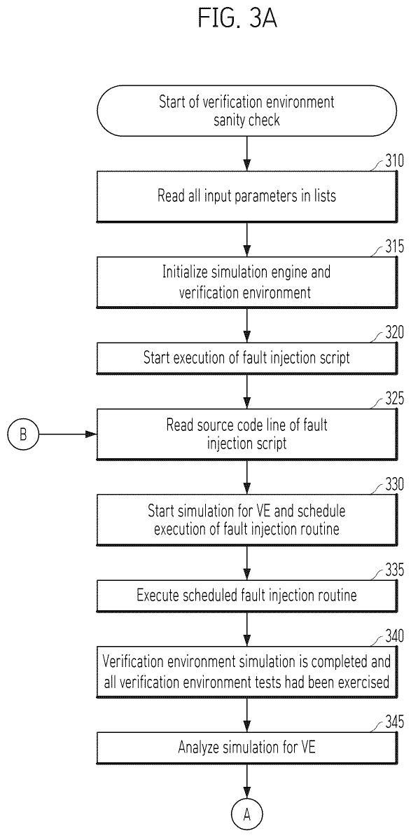

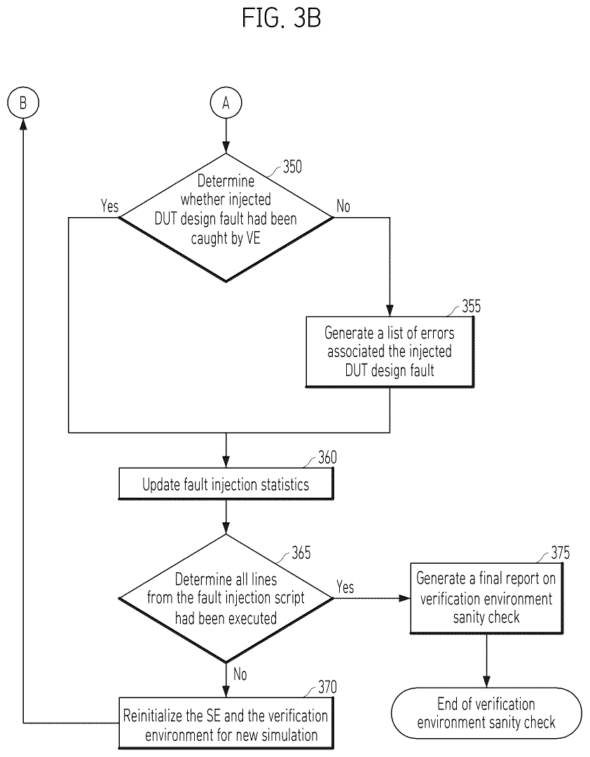

FIGS. 3A and 3B illustrate a flow of a verification environment sanity checking operation in accordance with one embodiment of the present invention. This operation may be performed by elements of the verification environment sanity checker (VESC) shown in FIG. 2.

Referring FIG. 3A, at 310, the FI 230 reads all input parameters in lists 232-234 supplied by VEP 210, HDLDP 220 and VESC user. At 315, the FI 230 initializes the simulation engine 240 and verification environment 100. At 320, the FI 230 starts execution of the fault injection script 232. At 325, the FI 230 reads source code line of the fault injection script 232. At 330, based on fault injection scenario of the fault injection script 232, the simulation engine 240 starts simulation for the VE 100 and schedules execution of fault injection routine. At 335, the simulation engine 240 executes scheduled fault injection routine. Based on the executed fault injection script source code expression, DUT design fault is injected. It is expected that injected design fault should be detected by the VE 100. At 340, the verification environment simulation is completed and all verification environment tests have been exercised. At 345, the VEP 210 analyzes the simulation for the VE 100.

Referring to FIG. 3B, at 350, the VEP 210 determines whether the injected DUT design fault had been caught by the VE 100. At 355, the VEP 210 generates a list of errors 231 associated the injected DUT design fault based on the determination result, and reports to the FI 230 one or more error messages including the list of errors.

At 360, the FI 230 updates fault injection statistics based on the error messages. At 365, the FI 230 determines all lines from the fault injection script 232 had been executed. At 370, when it is determined that all lines from the fault injection script 232 had not been executed, the FI 230 reinitializes the SE 240 and the verification environment 100 for a new simulation.

At 375, it is determined that all lines from the fault injection script 232 had been executed, the FI 230 generates a final report on verification environment sanity check. The final report may include the captured faults analysis and coverage.

### Example

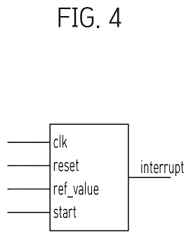

For the sake of illustrating the disclosed invention, the employment of an automated verification environment sanity checker may be considered on the simple DUT and the simple verification environment detailed below. In this example, the DUT 100B is a up counter (e.g., a 32-bit up counter) with input/output signals shown in FIG. 4 and listed in the following Table 1:

TABLE 1

| Signal name | Direction | Description |
|---|---|---|
| clk | input | Clock signal |
| reset | input | Synchronous reset signal |
| start | input | When asserted counter value, |
| | | incremented by 1 every clock cycle. |
| ref_value | input | Upon reaching reference value, counter |
| | | asserts interrupt signal. |
| interrupt | output | Asserted when counter reaches ref_value. |
| | | Signal remains asserted till counter value |
| | | becomes not equal to ref_value. |

As shown in FIG. 4 and Table 1, the 32-bit up counter has terminals for 4 input signals (clk, reset, start, ref_value) and 1 output signal (interrupt). Description of each signal is provided in Table 1.

In the verification environment 100, a mid-simulation reset scenario (but not implemented with an “up counter” reset feature check) is simulated. Therefore, the missing reset feature of the verification environment leaves DUT 100B with unverified DUT reset functionality. By coincidence, the reset feature of the up counter contains the design bug, the reset signal is unconnected in DUT 100B, and therefore reset assertion does not have any effect on the state of DUT 100B. Since the verification environment 100 does not have DUT reset feature check, the DUT bug will pass undetected and result in the faulty behavior of the up counter after reset issuance.

The disclosed invention in one embodiment makes it possible to expose both verification environment bugs and DUT bugs.

The verification environment sanity checker may be employed on DUT 100B and the verification environment 100. In this example, VEP 210 found, in the up counter verification environment, ref_value, start and interrupt features checkers with corresponding error messages. For each feature, the feature checker monitors DUT 100B for a proper operation and otherwise generates an error message. VEP 210 generates a list 231 of error messages corresponding to each checker. In particular, the list of errors messages includes invalid interrupt assertion for ref_value error message and asynchronous interrupt assertion (interrupt assertion does not match to start signal transitions) error message. HDL design parser (HDLDP) 220 creates a list 234 of up counter DUT components applicable for fault injection. Reset signal is among DUT components applicable for DUT fault injection. A reset signal value fixed in a high state is fault behavior applicable for the reset signal. Fault injection script 232 instructs to fix the reset signal in high state for ten simulation clock cycles upon DUT internal counter value reached a set value (e.g., 0x100). Since no reset feature checker was implemented, all tests in the verification environment 100 passed, and no error was generated by the DUT verification environment 100. Upon completion of tests regression, the verification environment sanity checker detects that faulty operation due to DUT reset feature being absent had not been reported by the DUT verification environment nevertheless having injected this fault with its expected error behavior. Therefore, the verification environment sanity checker generates a final report listing that the fault operation for the injected reset feature was not caught by the verification environment checker. Consequently, the final report of the verification environment sanity checker gives the opportunity to discover and correct DUT 100B and verification environment reset feature bugs. As such, the illustrated and disclosed embodiment allows for the detection of a missing reset feature and for implementing a consequent design reset feature based on the flaw discovery.

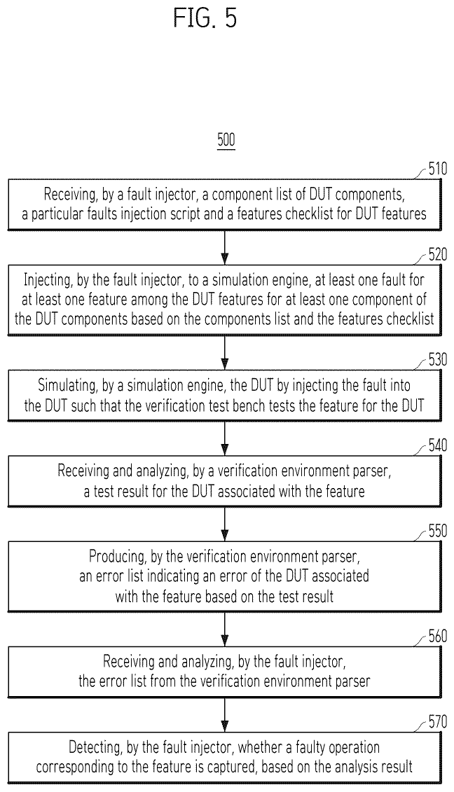

FIG. 5 is a flowchart illustrating a method 500 of a verification environment sanity check in accordance with an embodiment of the present invention. The method 500 operates a verification environment sanity checker coupled to a verification environment including a design under test (DUT) and a verification test bench.

Referring to FIG. 5, the method 500 includes, at operation 510, receiving, by a fault injector, a component list of DUT components, a particular faults injection script and a features checklist for DUT features.

Operation 520 includes injecting, by the fault injector, to a simulation engine, at least one fault for at least one feature among the DUT features for at least one component of the DUT components based on the components list and the features checklist.

Operation 530 includes simulating, by a simulation engine, the DUT by injecting the fault into the DUT such that the verification test bench tests the feature for the DUT.

Operation 540 includes receiving and analyzing, by a verification environment parser, a test result for the DUT associated with the feature.

Operation 550 includes producing, by the verification environment parser, an error list indicating an error of the DUT associated with the feature based on the test result.

Operation 560 includes receiving and analyzing, by the fault injector, the error list from the verification environment parser.

Operation 570 includes detecting, by the fault injector, whether a faulty operation corresponding to the feature is captured, based on the analysis result.

The method 500 further includes: generating, by the fault injector, a report associated with the detection of the faulty operation.

In some embodiments, the DUT includes a system-on-chip (SoC) module for a memory controller.

In some embodiments, the particular faults injection script includes an instruction set for combinational or sequential fault injections of two or more among incorrect finite state machine (FSM) state transition, unsynchronized clock domains clock phase shifting, incorrect modules interconnection, incorrect register value change, and communication protocol violations.

In some embodiments, the particular faults injection script is generated by the verification environment parser and afterward populated by a user.

In some embodiments, the components list is received from a design parser, and the design parser includes a Hardware Description Language (HDL) design parser.

In some embodiments, the simulation engine includes a Hardware Description Language (HDL) simulation engine.

In some embodiments, the particular faults injection script supports one or more faults injection scenarios in one of the HDL or other high-level program languages.

In some embodiments, the fault injector is coupled to the HDL simulation engine through a dedicated programming interface.

In some embodiments, the features checklist is provided by a user.

As described above, embodiments of the present invention provide an automated solution for verification environment sanity check for consistency with verified DUT features, minimization of verification components DUT specification misinterpretation, and design flaw identification both in the verification environment and in the DUT. Various embodiments of the present invention make it possible to promptly deploy an automated testing framework that checks verification environment completeness by generating DUT misbehavior.

Although the foregoing embodiments have been illustrated and described in some detail for purposes of clarity and understanding, the present invention is not limited to the details provided. There are many alternative ways of implementing the invention, as one skilled in the art will appreciate in light of the foregoing disclosure. The disclosed embodiments are thus illustrative, not restrictive. The present invention is intended to embrace all modifications and alternatives. Furthermore, the embodiments may be combined to form additional embodiments.

What is claimed is:

1. A verification environment sanity checker coupled to a verification environment including a design under test (DUT) and a verification test bench, the verification environment sanity checker comprising:
a verification environment parser coupled to the verification test bench;
a design parser coupled to the DUT, and configured to decompose the DUT to produce a component list of DUT components;
a simulation engine coupled to the verification environment, and configured to simulate the DUT; and
a fault injector coupled between the verification environment parser and the simulation engine, and configured to receive the components list, a particular faults injection script and a features checklist for DUT features, and inject, to the simulation engine, at least one fault for at least one feature of the DUT features for at least one component of the DUT components based on the components list and the features checklist such that the simulation engine simulates the DUT by injecting the fault into the DUT and the verification test bench tests the feature for the DUT,
wherein the injected at least one fault is expected to produce an expected error in the simulation of the DUT,
wherein the verification environment parser is configured to receive a test result for the DUT associated with the feature, analyze the test result and produce an error list indicating an error of the DUT associated with the feature based on the test result, and
wherein the fault injector is configured to receive the error list from the verification environment parser, analyze the error list, and detect whether a faulty operation corresponding to the feature is captured, based on the analysis result and the expected error in the simulation of the DUT.

2. The verification environment sanity checker of claim 1, wherein the fault injector is further configured to generate a report associated with the detection of the faulty operation.

3. The verification environment sanity checker of claim 2, wherein the DUT includes a system-on-chip (SoC) module for a memory controller.

4. The verification environment sanity checker of claim 3, wherein the particular faults injection script includes an instruction set for combinational or sequential fault injections of two or more among incorrect finite state machine (FSM) state transition, unsynchronized clock domains clock phase shifting, incorrect modules interconnection, incorrect register value change, and communication protocol violations.

5. The verification environment sanity checker of claim 4, wherein the particular faults injection script is generated by the verification environment parser and afterward populated by a user.

6. The verification environment sanity checker of claim 1, wherein the design parser includes a Hardware Description Language (HDL) design parser.

7. The verification environment sanity checker of claim 6, wherein the simulation engine includes a Hardware Description Language (HDL) simulation engine.

8. The verification environment sanity checker of claim 7, wherein the particular faults injection script supports one or more faults injection scenarios in one of the HDL or other high-level program languages.

9. The verification environment sanity checker of claim 7, wherein the fault injector is coupled to the HDL simulation engine through a dedicated programming interface.

10. The verification environment sanity checker of claim 1, the features checklist is provided by a user.

11. A method for operating a verification environment sanity checker coupled to a verification environment including a design under test (DUT) and a verification test bench, the method comprising:
receiving, by a fault injector, a component list of DUT components, a particular faults injection script and a features checklist for DUT features;
injecting, by the fault injector, to a simulation engine, at least one fault for at least one feature among the DUT features for at least one component of the DUT components based on the components list and the features checklist;
simulating, by a simulation engine, the DUT by injecting the fault into the DUT such that the verification test bench tests the feature for the DUT, wherein the injected fault is expected to produce an expected error in the simulating of the DUT;
receiving and analyzing, by a verification environment parser, a test result for the DUT associated with the feature;
producing, by the verification environment parser, an error list indicating an error of the DUT associated with the feature based on the test result;
receiving and analyzing, by the fault injector, the error list from the verification environment parser; and
detecting, by the fault injector, whether a faulty operation corresponding to the feature is captured, based on the analysis result and the expected error in the simulation of the DUT.

12. The method of claim 11, further comprising: generating, by the fault injector, a report associated with the detection of the faulty operation.

13. The method of claim 12, wherein the DUT includes a system-on-chip (SoC) module for a memory controller.

14. The method of claim 13, wherein the particular faults injection script includes an instruction set for combinational or sequential fault injections of two or more among incorrect finite state machine (FSM) state transition, unsynchronized clock domains clock phase shifting, incorrect modules interconnection, incorrect register value change, and communication protocol violations.

15. The method of claim 14, wherein the particular faults injection script is generated by the verification environment parser and afterward populated by a user.

16. The method of claim 11, wherein the components list is received from a design parser, and the design parser includes a Hardware Description Language (HDL) design parser.

17. The method of claim 16, wherein the simulation engine includes a Hardware Description Language (HDL) simulation engine.

18. The method of claim 17, wherein the particular faults injection script supports one or more faults injection scenarios in one of the HDL or other high-level program languages.

19. The method of claim 17, wherein the fault injector is coupled to the HDL simulation engine through a dedicated programming interface.

20. The method of claim 11, the features checklist is provided by a user.
